(19) United States
(12) Patent Application Publication
(10) Pub. No.: US 2006/0180398 A1
(43) Pub. Date: Aug. 17, 2006

(54) Integrated waffle pan apparatus and method

(76) Inventors: Ibrahim Khalil, Lake Barrington, IL (US); John G. Eleftherakis, Stillwater, OK (US); Abdul Karim Maoued, Stillwater, OK (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/050,867

(22) Filed: Feb. 7, 2005

(51) Int. Cl. F16N 31/00

(52) U.S. Cl. 184/106

(57) ABSTRACT

A method and apparatus of capturing and retaining debris in a fluid housing, including a transmission or engine includes a series of depressions forming a grid in the transmission pan, engine pan or any other fluid housing.

### FIELD OF THE INVENTION

The present invention relates generally to fluid filters in automotive vehicles. More particularly, the present invention relates to a transmission pan or engine pan for capturing contaminants.

### BACKGROUND OF THE INVENTION

An automotive transmission is a compressed hydraulic circuit whose primary purpose is to allow an engine to operate in a narrow RPM (revolutions per minute) while providing a wide range of output speeds. The transmission needs a fluid, typically a light oil to provide lubrication. As the fluid circulates through the transmission, the fluid collects damaging particulates which make it desirable to filter the fluid at a point prior to the circulation.

Commonly, fluid filtration takes place as the fluid is drawn back into the circulation from the sump or reservoirs. Transmission fluid filters may be employed to remove debris from the fluid circulating through an automatic transmission of an automotive vehicle. The fluid flows through the filtration media of a filter which may remove sediment, debris or impurities.

Prior art filters may utilize a porous filter media interposed between the sump and the pump to filter the fluid. Existing filtration systems may have a number of disadvantages. For example, filtering small particulates as a fluid is drawn back into circulation may create a bottle neck effect that may lead to drops in fluid pressure. This is a particular concern during cold flow conditions. Furthermore, because these filters provide all the filtration required, the single supply side filter may clog when removing large amounts or large sizes of contaminant, resulting in poor performance and frequent, expensive filter changes.

The presence of large chips is a problem associated with fluid filtration. These chips may jam valves, plug oil packages and settle in places to become entrained in the oil after initial operation. A common approach to keeping these chips out of transmissions, fits each valve with an encapsulated screen so that chips cannot affect individual valves. However, this has not been very successful. The screens may become blocked with debris and prevent full fluid flow through the system, leading to costly repairs. The same can be said of an engine or a suction side engine filter.

Accordingly, it is desirable to provide a simple and cost effective means to filter out the contaminant that settle on the bottom of a transmission or engine pan and prevent the clogging of the transmission filters. In addition to using filters to filter out the transmission oil, it is desirable to develop an apparatus and method that maximizes the settling and trapping phenomena of sediment in fluid housings, including transmissions and engines. Thus, it is desirable to provide a cost effective way to capture and contain sediment so that filters are kept free of clogs.

### SUMMARY OF THE INVENTION

The foregoing needs are met, to a great extent, by the present invention, wherein in one aspect an apparatus is provided that in some embodiments, takes advantage of the settling and trapping phenomena of sediment that naturally occurs due to gravity.

In some preferred embodiments of the invention, gravity brings debris particles to the bottom and magnets are utilized to further attract and capture ferromagnetic particles in the fluid, including transmission or engine fluid. Some embodiments include magnets at the lowest point, to increase contaminant collection and retention.

In accordance with one embodiment of the present invention, a fluid housing for use with a fluid having particulate material includes an internal surface having a set of depressions formed therein to trap particulate material in the fluid.

In accordance with another embodiment of the present invention, a fluid housing includes an internal surface having a set of depressions formed therein to trap particulate material in the fluid and a magnet to attract the particulate material.

In accordance with another embodiment of the present invention, a transmission system includes a fluid housing having an internal surface with a set of depressions formed therein and a suction side transmission filter disposed in the fluid housing.

In accordance with yet another embodiment of the present invention, a transmission system for transmission fluid includes an internal surface having a set of depressions formed therein to trap particulate material in the fluid and a magnet coupled to the set of depressions to trap particulate material in the fluid.

In accordance with still another embodiment of the present invention, an engine system for engine oil includes an engine pan having a set of depressions formed therein to trap particulate material in the fluid and a suction side engine filter disposed in the engine pan.

In accordance with another embodiment of the present invention, an engine system includes an internal surface having a set of depressions formed therein to trap particulate material in the fluid and a magnet coupled to the set of depressions to trap particulate material in the fluid.

In accordance with still another embodiment of the present invention, a sheet for placement in a fluid housing includes, a top surface having a series of depressions formed therein and a bottom surface adapted to attach the sheet to an internal surface of the fluid housing.

In accordance with yet another embodiment of the present invention, a method of capturing debris in a fluid housing includes forming a set of depressions in the bottom pan of the fluid housing and affixing the bottom pan to the transmission.

In accordance with still another embodiment of the present invention, a method of capturing debris in a fluid housing includes passing fluid over a set of depressions formed in an internal surface of a housing and entrapping particles in the set of depressions.

In accordance with yet another embodiment of the present invention, a system for capturing debris in a fluid housing includes a means for defining a set of depressions in the bottom of the fluid housing, a means for affixing the bottom pan to the transmission and a magnetic means for attracting particulates to the set of depressions

In accordance with still another embodiment of the present invention, a system for capturing debris in a fluid housing includes a means for passing fluid over a set of depressions and a means for entrapping particles in the set of depressions.

There has thus been outlined, rather broadly, certain embodiments of the invention in order that the detailed description herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a transmission pan according to a preferred embodiment of the invention.

FIG. 2 is a cutaway view of a transmission case.

FIG. 3 is a perspective view of the sheet-like insert according to a preferred embodiment of the invention.

FIG. 4a is a perspective view of a fluid housing coupled to a magnet.

FIG. 4b is a perspective view of the bottom of the fluid housing coupled to a magnet of FIG. 4a.

FIG. 5 is a bottom plan view of the bottom of a fluid housing showing the grid.

FIG. 6 is a perspective view of an engine pan with the grid, coupled to a magnet.

FIG. 7 is a perspective view of a transmission pan coupled to a magnet.

### DETAILED DESCRIPTION

Embodiments of the present invention provide an apparatus that in some embodiments, takes advantage of the settling and trapping phenomena of sediment that naturally occurs due to gravity. A preferred embodiment includes a series of depressions or ribs forming a grid at the bottom of a fluid housing such as a transmission pan, looking somewhat like a “waffle iron” to attract, capture and retain debris as an additional manner of filtration. This allows the fluid filter to perform efficiently without the threat of the filter becoming clogged with larger debris. Thus, the series of depressions, or grid, acts as a “coarse flow” filter, allowing the suction side filter to act as a “fine flow” filter in that the filter filters fluid that has already had larger impurities removed.

A series of depressions or ribs forming a grid that looks like a “waffle iron” is formed, for example by stamping, at the bottom of the transmission pan or engine pan, such that when the fluid flows over the grid, contaminants settle on the bottom of the pan and are captured in the grid depressions. The grid may be formed for example, of upwardly extending ribs that create cavities between the ribs, or be formed with downwardly extending depressions. The series of depressions take advantage of the settling and trapping phenomena of sediment using the force of gravity. Transmission or engine fluid often picks up debris, particulate material or impurities and this debris may jam valves or plug oil passages. The debris may also settle in places to become entrained in the oil after initial operation.

Embodiments of the invention will now be described with reference to the drawing figures, wherein like reference numerals denote like elements.

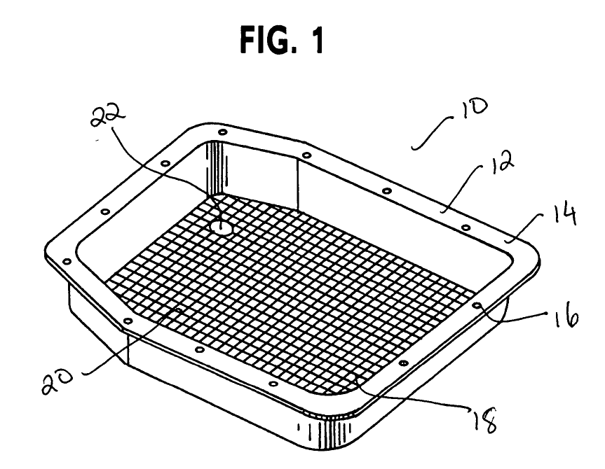

FIG. 1 is a perspective view of a fluid housing 10, where a preferred embodiment of the present invention includes a transmission pan 12. Transmission pan 12 includes a transmission pan mounting flange 14, which contains openings 16 for mounting the pan to a transmission using bolts. In addition, the transmission pan 12 has a transmission pan bottom 18 that has the series of ribs or depressions forming a grid 20 and a pan drain hole 22. The housing, such as for example a transmission pan or engine pan with the grid, contains low flow stagnant oil locations that attract and hold debris better than pans or filters without the series of depressions. The transmission pan or engine pan may easily be adapted to any manufacturers' engine or transmission. There are typically two types of transmissions, one with a bottom pan and one with a split case, which lacks a bottom pan.

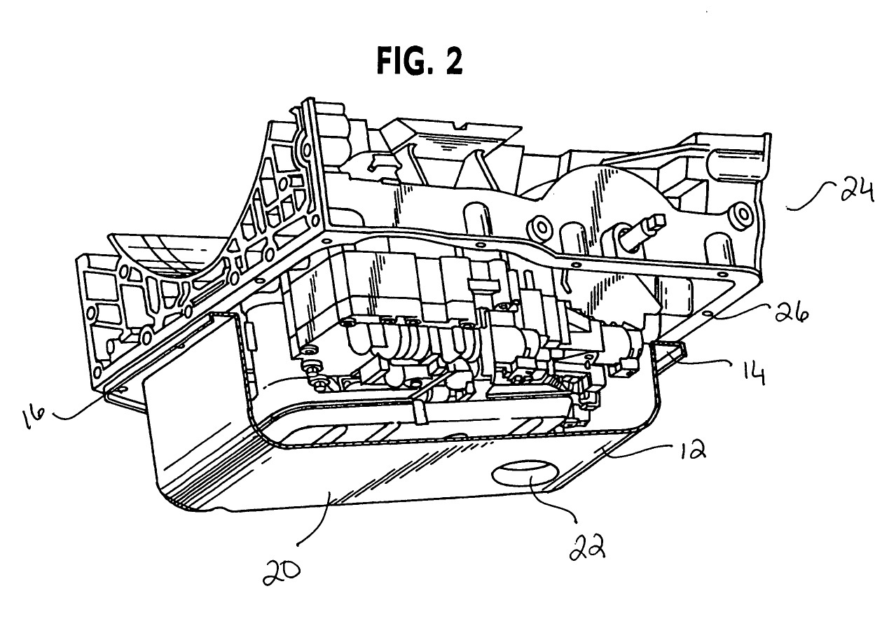

FIG. 2 is a perspective view of a transmission case 24. The transmission case 24 also includes openings 26 for mounting the transmission case 24 to the transmission pan mounting flange 14 at the pan's openings 16. The transmission pan 12 has the pan drain hole 22 at the transmission pan bottom 20.

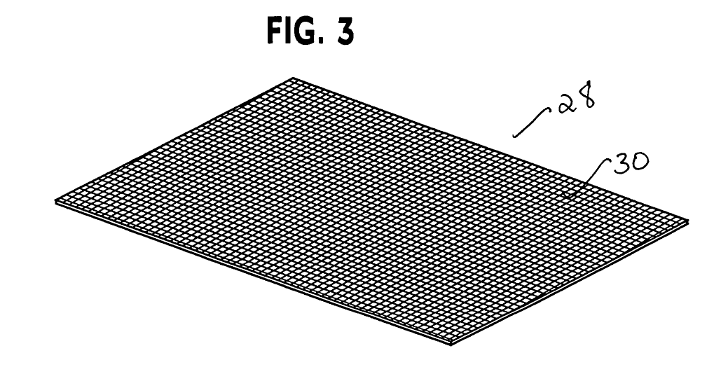

FIG. 3 is a perspective view of the sheet-like insert 28 that may be made of a magnetic material and have the grid 30 formed on it. The insert 28 may then be placed inside any fluid housing including, a transmission pan or engine pan. In another preferred embodiment of the present invention, a separate plastic or metallic sheet may be stamped with a series of depressions or ribs to form the grid and then be placed inside the transmission or engine pan. This is particularly useful for a split case transmission. The sheet may also be fashioned of a magnetic material including a molded ceramic.

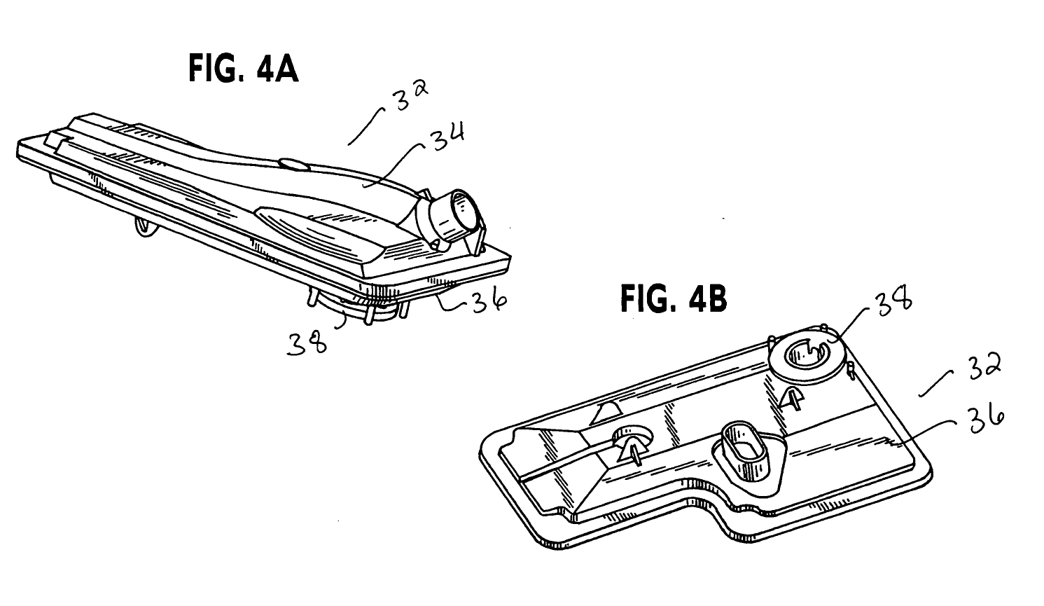

FIG. 4a illustrates another type of fluid housing, such as a suction side fluid filter 32. This suction side fluid filter 32 is placed inside the transmission pan or engine pan and filters the fluid. The typical filter includes an upper housing 34, a lower housing 36 and a media insert (not shown) placed between the upper and lower components of the housing. The fluid enters the filter and circulates through the media that removes debris or particulate material and exits from the filter to circulate through the transmission or engine. This figure illustrates another preferred embodiment of the present invention in that the fluid housing is coupled to a magnet 38. FIG. 4b is yet another illustration of the magnet 38 coupled to the fluid filter 32. Although the magnet 38 is shown coupled externally, the magnet 38 may readily be placed on an internal surface of the filter housing. The magnet 38 may be of any shape or size as can be seen by the illustrated circular magnet 38.

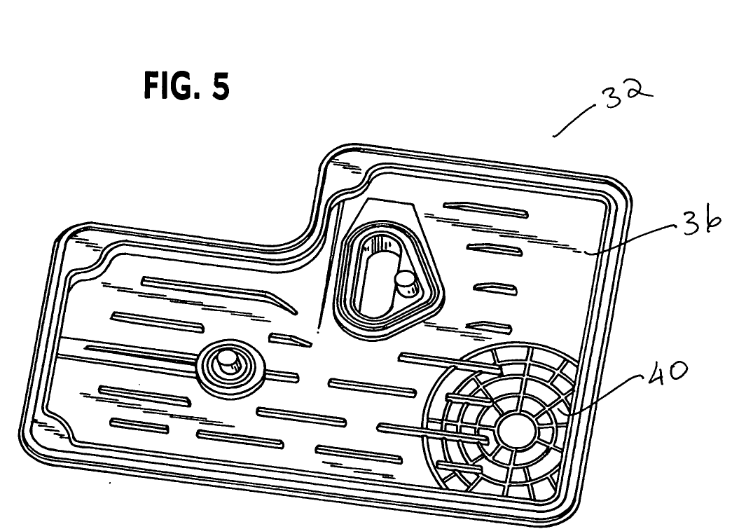

FIG. 5 is a representation of the lower housing 36 of a suction side fluid filter 32 showing the series of depressions or ribs 40. This figure further illustrates the varied nature of the grid in that the grid may be of any shape, size or pattern. The present illustration depicts a series of radiating circles with additional ribs 45 degrees from each other.

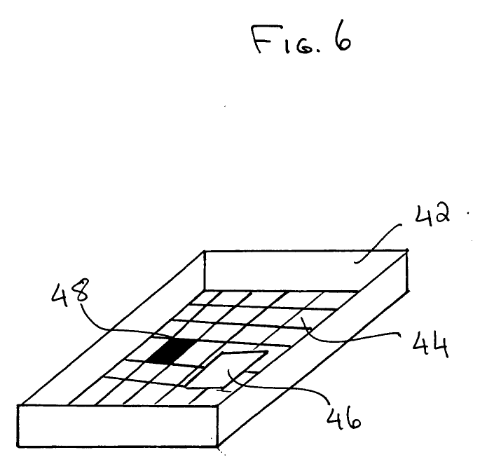

FIG. 6 illustrates another preferred embodiment of the present invention in that the series of depressions or ribs 44 may be formed on the internal surface of an engine pan 42. In addition, the figure also shows the magnet 46 coupled to the internal surface of the engine pan. Magnet 46 overlays the grid 44, covering a surface area of the grid, whereas magnet 48 rests within the depressions or ribs. Magnets may be used to capture ferromagnetic particles within the fluid flow. The magnets may be coupled to the inside or the outside of the fluid housing. Where the fluid housing is metallic, it is preferred that the magnet be placed inside the fluid housing. However, in the case of a non-metallic fluid housing, the magnet may be inside or outside the fluid housing. The magnet may also be a single sheet overlaying the series of depressions or may be a plurality of smaller magnets affixed into the series of depressions or ribs. The single sheet insert may also be formed of a magnetized material, such as a ceramic molded magnet.

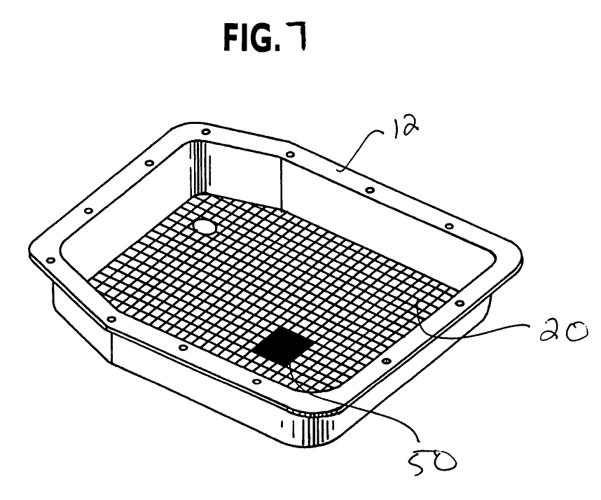

FIG. 7 shows the transmission pan 10 coupled to a magnet 50 on its internal surface, and the grid 20. Although this figure shows the magnet coupled to the internal surface, the magnet may readily be coupled to the external surface of the transmission pan.

A preferred embodiment of the present invention includes stamping the transmission pan or engine pan to create a series of depressions. The series of depressions may be of any geometry or size. Shapes may also be a repeating series of rectangles, squares, circles or a radiating pattern of these geometries. There may be any number of depressions from one to greater than one. Also, rather than forming depressions, a series of upwardly extending ribs may be formed to capture debris. These ribs may also be of any geometry, size or a radiating pattern as discussed above.

The depressions or ribs in the transmission pan or engine pan are, in some embodiments placed at the bottom of the pan to allow the force of gravity to act on the impurities to allow them to fall into the grooves of the series of depressions or ribs. The addition of magnets increases the capturing and retention of ferromagnetic particles. In a preferred embodiment of the present invention, it is possible to stamp a magnetic sheet with a series of depressions or ribs and place the sheet inside a conventional engine pan or transmission pan including a split case transmission.

In alternate embodiments of the present invention, a transmission pan may have the series of depressions or ribs formed therein. It is also possible to have an engine pan with a series of depressions or ribs formed therein.

For a split case transmission, a stamped sheet containing a series of depressions may be placed at the bottom, overlaying the split because a split case transmission contains no bottom pan. A magnet may also be used to increase the attraction and retention of debris whereby the magnet may be coupled to the inside or the outside of the series of depressions or ribs.

While the presently claimed invention relates to the transmission and engine of an automotive vehicle, this type of apparatus and method may be used with any device requiring fluid filtration.

Although, the grid is shown on an internal surface of the transmission pan, it will be appreciated that depressions can be applied to other fluid housings as well. Also, although the device is useful to filter fluids in transmissions and engines, it can also be used for example, on suction side transmission or engine filters.

The presently claimed invention has broad application, particularly in the automotive industry in that the series of depressions or grid, may be used with any transmission or engine. In addition, existing transmissions or engines may readily be adapted to contain the series of depressions or grid by way of retrofitting the transmission bottom pan or engine bottom pan.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A fluid housing for use with a fluid having particulate material comprising:
an internal surface having a set of depressions formed therein to trap particulate material in the fluid.

2. The fluid housing for use with a fluid having particulate material of claim 1, wherein the set of depressions have a regular repeating geometry.

3. The fluid housing for use with a fluid having particulate material of claim 2, wherein the geometry of the set of depressions comprises a first plurality of parallel grooves.

4. The fluid housing for use with a fluid having particulate material of claim 1, wherein the set of depressions comprises a second plurality of parallel grooves at an angle to the first plurality.

5. The fluid housing for use with a fluid having particulate material of claim 1, wherein the fluid housing is a transmission pan.

6. The fluid housing for use with a fluid having particulate material of claim 1, wherein the fluid housing is an engine pan.

7. A fluid housing for use with a fluid having particulate material comprising:
an internal surface having a set of depressions formed therein to trap particulate material in the fluid; and
a magnet to attract the particulate material.

8. The fluid housing for use with a fluid having particulate material of claim 7, wherein the magnet is disposed on top of the set of depressions.

9. The fluid housing for use with a fluid having particulate material of claim 7, wherein the magnet is integral with the set of depressions.

10. The fluid housing for use with a fluid having particulate material of claim 7, wherein the magnet is disposed on top of the set of depressions and covers at least part of a surface area of the set of depressions.

11. The fluid housing for use with a fluid having particulate material of claim 7, wherein the magnet is coupled to the outside of the fluid housing.

12. The fluid housing for use with a fluid having particulate material of claim 7, wherein the fluid housing is a transmission pan.

13. The fluid housing for use with a fluid having particulate material of claim 7, wherein the fluid housing is an engine pan.

14. A transmission system comprising:
a fluid housing having an internal surface with a set of depressions formed therein; and
a suction side transmission filter disposed in the fluid housing.

15. The transmission system of claim 14, wherein the set of depressions have a regular repeating geometry.

16. The transmission system of claim 15, wherein the geometry of the set of depressions comprises a first plurality of parallel grooves.

17. The transmission system of claim 14, wherein the set of depressions comprises a second plurality of parallel grooves of an angle to the first plurality.

18. A sheet for placement in a fluid housing comprising:
a top surface having a series of depressions formed therein; and
a bottom surface adapted to attach the sheet to an interior surface of the fluid housing.

19. The sheet of claim 18, placed inside a transmission pan.

20. The sheet of claim 18, placed inside an engine pan.

21. The sheet of claim 18, placed inside a fluid housing.

22. The sheet of claim 18, placed inside a split case transmission.

23. The sheet of claim 18, further comprising:
a magnet coupled to the sheet.

24. The sheet of claim 18, wherein the sheet is metallic.

25. The sheet of claim 18, wherein the sheet is plastic.

26. A method of capturing debris in a fluid housing comprising:
defining a set of depressions in the bottom pan of the fluid housing; and
affixing the bottom pan to the transmission.

27. The method of claim 26, further comprising the step of coupling a magnet to the set of depressions.

28. A method of capturing debris in a fluid housing comprising:
passing fluid over a set of depressions formed in an internal surface of a housing; and
entrapping particles in the set of depressions.

29. A system for capturing debris in a fluid housing comprising:
means for defining a set of depressions in the bottom of the fluid housing;
means for affixing the bottom pan to the transmission; and
magnetic means for attracting particulates to the set of depressions.

30. A system for capturing debris in a fluid housing comprising:
means for passing fluid over a set of depressions; and
means for entrapping particles in the set of depressions.
